(19) United States
(12) Patent Application Publication
(10) Pub. No.: US 2007/0291170 A1
(43) Pub. Date: Dec. 20, 2007

(54) IMAGE RESOLUTION CONVERSION METHOD AND APPARATUS

(75) Inventors: Seung-hoon Han, Seoul (KR); Seung-joon Yang, Seoul (KR); Rae-hong Park, Seoul (KR); Jun-yong Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignees: Samsung Electronics Co., Ltd., Suwon-si (KR); Industry-University Cooperation Foundation Sogang University, Seoul (KR)

(21) Appl. No.: 11/760,806

(22) Filed: Jun. 11, 2007

(30) Foreign Application Priority Data
Jun. 16, 2006 (KR) 10-2006-0054375

(51) Int. Cl. G06K 9/32; H04N 7/01

(52) U.S. Cl. 348/458; 382/299

(57) ABSTRACT

An image resolution conversion method and apparatus based on a projection onto convex sets (POCS) method are provided. The image resolution conversion method comprises detecting an edge region and a direction of the edge region in an input low-resolution image frame in order to generate an edge map and edge direction information, generating a directional point spread function based on the edge map and the edge direction information, interpolating the input low-resolution image frame into a high-resolution image frame, generating a residual term based on the input low-resolution image frame, the high-resolution image frame, and the directional point spread function, and renewing the high-resolution image frame according to a result of comparing the residual term with a threshold.

### CROSS-REFERENCE TO RELATED PATENT APPLICATION

This application claims priority from Korean Patent Application No. 10-2006-0054375, filed on Jun. 16, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to image resolution conversion, and more particularly, to image resolution conversion based on a projection onto convex sets (POCS) method.

2. Description of the Related Art

A projection onto convex sets (POCS) method involves generating a convex set with respect to an image frame and obtaining an image having an improved display quality using the generated convex set.

FIG. 1 is a block diagram of a related art image resolution converter 100 based on POCS.

Referring to FIG. 1, the related art image resolution converter 100 operates as follows.

If a low-resolution image frame y(m₁,m₂,k) is input, an initial interpolation unit 110 initially interpolates the low-resolution image frame y(m₁,m₂,k) into a high-resolution image frame x(n₁,n₂,k) and a motion estimation unit 120 performs motion estimation on the initially interpolated high-resolution image frame x(n₁,n₂,k) in order to generate a motion vector u=(u,v). A POCS reconstruction unit 130 outputs a super-resolution image frame \hat{x}(n₁, n₂, tᵣ) using the low-resolution image frame y(m₁, m₂,k), the initially interpolated high-resolution image frame x(n₁, n₂,k), the motion vector u=(u,v), and a point spread function hₜ_{ᵣ}(n₁, n₂;m₁,m₂;k).

FIG. 2 is a block diagram of the POCS reconstruction unit 130 illustrated in FIG. 1.

A residual calculation unit 132 calculates and outputs a residual term.

More specifically, the residual calculation unit 132 corrects a difference between motions of a low-resolution image frame and a high-resolution image frame using a motion vector and calculates Equation (1) in order to generate a residual term r^{(x)}(m₁, m₂,k).

$${r}^{( x )} ( {m}_{1} , {m}_{2} , k ) = y ( {m}_{1} , {m}_{2} , k ) - {\sum }_{( {n}_{1} , {n}_{2} )} x ( {n}_{1} , {n}_{2} , {t}_{r} ) {h}_{{t}_{r}} ( {n}_{1} , {n}_{2} , {m}_{1} , {m}_{2} , k ) , \qquad ( 1 )$$

where (m₁, m₂) indicates the coordinates of a pixel of a low-resolution image frame, and (n₁, n₂) indicates the coordinates of a pixel of a high-resolution image frame. y(m₁, m₂,k) indicates a k^{th} low-resolution image frame, x(n₁, n₂,tᵣ) indicates a high-resolution image frame at a time tᵣ, and hₜ_{ᵣ}(n₁, n₂;m₁,m₂;k) indicates a point spread function reflecting motion information, blurring, and down sampling.

The residual calculation unit 132 generates a convex set Cₜ_{ᵣ}(m₁,m₂,k) as follows.

Cₜ_{ᵣ}(m₁,m₂,k)={r(n₁,n₂,tᵣ)||r^{(x)}(m₁,m₂,k)|≦δ₀(m₁,m₂,k)} (2)

where δ₀(m₁,m₂,k) indicates a threshold used in the generation of the convex set. The convex set Cₜ_{ᵣ}(m₁,m₂,k) means a set of high-resolution image frames x(n₁,n₂,tᵣ) satisfying a condition that the residual term r^{(x)}(m₁,m₂,k) is less than or equal to the threshold δ₀(m₁,m₂,k) as in Equation (1).

A projection unit 134 outputs the super-resolution image frame \hat{x}(n₁,n₂,tᵣ) , and an iteration unit 136 renews the high-resolution image frame x(n₁,n₂,tᵣ) if the condition for the convex set Cₜ_{ᵣ}(m₁,m₂,k) is satisfied, i.e., if the residual term r^{(x)}(m₁,m₂,k) is greater than the threshold δ₀(m₁,m₂,k) or less than a predetermined threshold −δ₀(m₁,m₂,k), as in Equation (3).

If the condition for the convex set is satisfied, i.e., if the residual term r^{(x)}(m₁,m₂,k) is less than or equal to the threshold δ₀(m₁,m₂,k) the projection unit 134 outputs the super-resolution image frame \hat{x}(n₁,n₂,tᵣ) without renewal of the high-resolution image frame x(n₁,n₂,tᵣ) by the iteration unit 136.

$$x ( {n}_{1} , {n}_{2} , {t}_{r} ) = x ( {n}_{1} , {n}_{2} , t ) + \{ \begin{matrix}\frac{( {r}^{( x )} ( {m}_{1} , {m}_{2} , k ) - {δ}_{0} ( {m}_{1} , {m}_{2} , k ) ) {h}_{{t}_{r}} ( {n}_{1} , {n}_{2} , {m}_{1} , {m}_{2} , k )}{{\sum }_{{o}_{1}} {\sum }_{{o}_{2}} {h}_{{t}_{r}}^{2} ( {o}_{1} , {o}_{2} , {m}_{1} , {m}_{2} , k )} , \\ 0 , \\ \frac{( {r}^{( x )} ( {m}_{1} , {m}_{2} , k ) + {δ}_{0} ( {m}_{1} , {m}_{2} , k ) ) {h}_{{t}_{r}} ( {n}_{1} , {n}_{2} , {m}_{1} , {m}_{2} , k )}{{\sum }_{{o}_{1}} {\sum }_{{o}_{2}} {h}_{{t}_{r}}^{2} ( {o}_{1} , {o}_{2} , {m}_{1} , {m}_{2} , k )} ,\end{matrix} \\ \begin{matrix}{r}^{( x )} ( {m}_{1} , {m}_{2} , k ) > {δ}_{0} ( {m}_{1} , {m}_{2} , k ) \\ \vert {r}^{( x )} ( {m}_{1} , {m}_{2} , k ) \vert \leq {δ}_{0} ( {m}_{1} , {m}_{2} , k ) \\ {r}^{( x )} ( {m}_{1} , {m}_{2} , k ) < {δ}_{0} ( {m}_{1} , {m}_{2} , k )\end{matrix} , \qquad ( 3 )$$

where terms in the denominator indicate normalization for making a sum of weights equal to 1, and O₁ and O₂ indicate mask sizes in the normalization. In other words, in the case of a 5×5 mask, O₁=5 and O₂=5.

Since a related art image resolution converting method based on POCS uses a colinear point spread function during resolution conversion, high-frequency components are not fully reflected, resulting in degradation of display quality.

### SUMMARY OF THE INVENTION

The present invention provides an image resolution conversion method and apparatus, in which an edge is detected and an appropriate point spread function corresponding to the direction of the detected edge is adopted, thereby improving a resolution while maintaining the detected edge.

According to one aspect of the present invention, there is provided an image resolution conversion method. The image resolution conversion method includes detecting an edge region and the direction of the edge region in an input low-resolution image frame in order to generate an edge map and edge direction information, generating a directional point spread function based on the generated edge map and edge direction information, interpolating the input low-resolution image frame into a high-resolution image frame, generating a residual term using the input low-resolution image frame, the interpolated high-resolution image frame, and the directional point spread function, and renewing the interpolated high-resolution image frame according to a result of comparing the residual term with a predetermined threshold.

The image resolution conversion method may further predicting a motion vector by estimating motion of the interpolated high-resolution image frame, generating a motion outlier map by detecting pixels having a large amount of motion prediction errors from the motion-estimated image frame, and not renewing the interpolated high-resolution image frame for the pixels having a large amount of motion prediction errors based on the motion outlier map.

An area having larger gradients with respect to horizontal and vertical directions than a predetermined threshold may be determined to be the edge region in the low-resolution image frame.

The edge direction information may be generated using a horizontal change rate of the low-resolution image frame and a vertical change rate of the low-resolution image frame.

The edge direction information may be approximated to four directions including a horizontal direction, a vertical direction, a diagonal direction, and an anti-diagonal direction.

The generation of the directional point spread function may include generating a colinear Gaussian function for a pixel in a non-edge region.

The generation of the directional point spread function may include generating a one-dimensional Gaussian function for a pixel in the edge region according to the direction of the edge region.

The interpolation may be performed using bilinear interpolation or bicubic interpolation.

The residual term may be obtained by subtracting a product of the interpolated high-resolution image frame and the directional point spread function from the input low-resolution image frame.

The renewal may be performed when the absolute value of the residual term is greater than a predetermined threshold.

According to another aspect of the present invention, there is provided an image resolution conversion apparatus including an edge detection unit, a directional function generation unit, an interpolation unit, a residual term calculation unit, and an iteration unit. The edge detection unit detects an edge region and the direction of the edge region in an input low-resolution image frame in order to generate an edge map and edge direction information. The directional function generation unit generates a directional point spread function based on the generated edge map and edge direction information. The interpolation unit interpolates the input low-resolution image frame into a high-resolution image frame. The residual term calculation unit generates a residual term using the input low-resolution image frame, the interpolated high-resolution image frame, and the directional point spread function. The iteration unit renews the interpolated high-resolution image frame according to a result of comparing the residual term with a predetermined threshold.

The image resolution conversion apparatus may further include a motion estimation unit that predicts a motion vector by estimating motion of the interpolated high-resolution image frame and a motion outlier detection unit that generates a motion outlier map by detecting pixels having a large amount of motion prediction errors from the motion-estimated image frame.

The edge detection unit may determine an area having larger gradients with respect to horizontal and vertical directions than a predetermined threshold to be the edge region in the low-resolution image frame.

The edge detection unit may generate the edge direction information using a horizontal change rate of the low-resolution image frame and a vertical change rate of the low-resolution image frame.

The edge detection unit may approximate edge direction information to four directions including a horizontal direction, a vertical direction, a diagonal direction, and an anti-diagonal direction.

The directional point spread function generation unit may generate a colinear Gaussian function for a pixel in a non-edge region.

The directional point spread function generation unit may generate a one-dimensional Gaussian function for a pixel in the edge region according to the direction of the edge region.

The interpolation unit may perform the interpolation using bilinear interpolation or bicubic interpolation.

The residual term calculation unit may calculate the residual term by subtracting a product of the interpolated high-resolution image frame and the directional point spread function from the input low-resolution image frame.

The iteration unit may perform the renewal when the absolute value of the residual term is greater than a predetermined threshold.

The iteration unit may do not renew the interpolated high-resolution image frame for the pixels having a large amount of motion prediction errors based on the motion outlier map.

### BRIEF DESCRIPTION OF THE DRAWINGS

The above and other aspects of the present invention will become more apparent by describing in detail an exemplary embodiment thereof with reference to the attached drawings in which:

FIG. 1 is a block diagram of a related art image resolution converter based on a POCS method;

FIG. 2 is a block diagram of a POCS reconstruction unit illustrated in FIG. 1;

FIG. 3 is a block diagram of an image resolution conversion apparatus according to an exemplary embodiment of the present invention;

FIG. 4 is a view for explaining calculation of edge direction information according to an exemplary embodiment of the present invention;

FIG. 5 is a view for explaining an edge direction according to an exemplary embodiment of the present invention;

FIG. 6 is a view for explaining a colinear Gaussian function;

FIG. 7 is a view for explaining the shape of a one-dimensional Gaussian function according to the edge direction; and

FIG. 8 is a flowchart illustrating an image resolution conversion method according to an exemplary embodiment of the present invention.

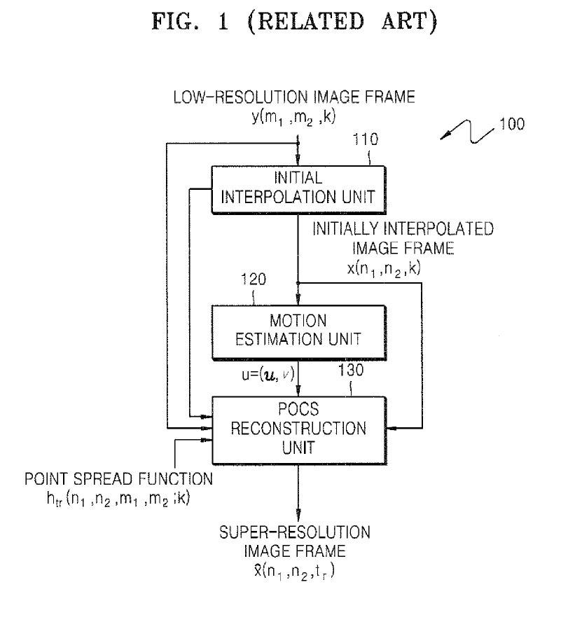

### DETAILED DESCRIPTION OF EXEMPLARY EMBODIMENTS OF THE INVENTION

Hereinafter, exemplary embodiments of the present invention will be described in detail with reference to the accompanying drawings.

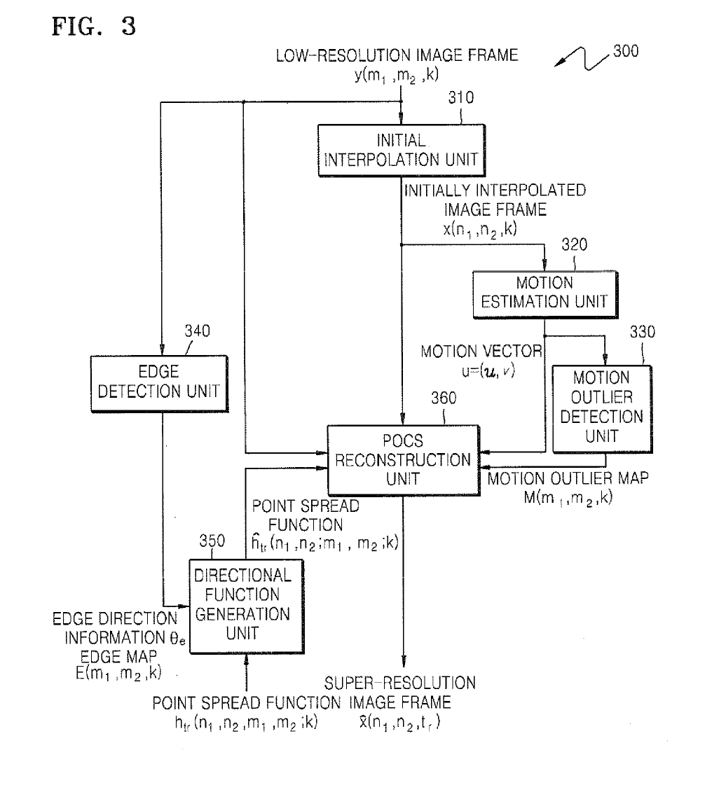

FIG. 3 is a block diagram of an image resolution conversion apparatus 300 according to an exemplary embodiment of the present invention.

The image resolution conversion apparatus 300 includes an initial interpolation unit 310, a motion estimation unit 320, a motion outlier detection unit 330, an edge detection unit 340, a directional function generation unit 350, and a POCS reconstruction unit 360.

The initial interpolation unit 310 initially interpolates an input low-resolution image frame y(m₁,m₂,k) into a high-resolution image frame x(n₁,n₂,k). Initial interpolation may be bilinear interpolation or bicubic interpolation, which is well known to those of ordinary skill in the art and thus will not be described here.

The motion estimation unit 320 performs motion estimation on a k^{th} initially interpolated high-resolution image frame x(n₁,n₂,k) at a time tᵣ in order to predict a motion vector u=(u,v). A motion estimation algorithm may be performed using block-based motion estimation, pixel-based motion estimation, or a robust optical flow algorithm. Since block-based motion estimation has problems such as motion prediction errors and block distortion, pixel-based motion estimation and the robust optical flow algorithm are used for motion estimation in an exemplary embodiment of the present invention.

The robust optical flow algorithm predicts a motion vector using a motion outlier. The motion outlier can be classified into an outlier with respect to data preservation constraints and an outlier with respect to spatial coherence constraints. In general, a region having a large amount of motion is detected as the outlier with respect to the data preservation constraints, and an edge portion of an image frame or a region having a sharp change in a pixel value is detected as the outlier with respect to the spatial coherence constraints.

An outlier map M_{E}_{_{D}}(n₁,n₂,k) with respect to the data preservation constraints is expressed as follows.

$${M}_{{E}_{D}} ( {n}_{1} , {n}_{2} , k ) = \{ \begin{matrix}1 , & if ( u , v ) ∈ {outlier}_{{E}_{D}} \\ 0 , & otherwise\end{matrix} \qquad ( 4 )$$

An outlier map M_{E}_{_{S}}(n₁,n₂,k) with respect to the spatial coherence constraints is expressed as follows.

$${M}_{{E}_{S}} ( {n}_{1} , {n}_{2} , k ) = \{ \begin{matrix}1 , & if ( u , v ) ∈ {outlier}_{{E}_{S}} \\ 0 , & otherwise\end{matrix} , \qquad ( 5 )$$

where outlier_{E}_{_{D}} and outlier_{E}_{_{S}} indicate the threshold of an outlier with respect to an objective function E_{D} for the data preservation constraints and the threshold of an outlier with respect to an objective function E_{S} for the spatial coherence constraints. The outlier map M_{E}_{_{S}}(n₁,n₂,k) with respect to the spatial coherence constraints can provide information about brightness change in an image frame where intensity variation such as illumination change occurs.

Block-based motion estimation, pixel-based motion estimation, the robust optical flow algorithm are well known to those of ordinary skill in the art and thus will not be described here.

The motion outlier detection unit 330 detects pixels having a large amount of motion prediction errors based on motion information estimated by the motion estimation unit 320 in order to generate a motion outlier map M(m₁,m₂,k).

The motion outlier map M(m₁,m₂,k) obtained by the motion outlier detection unit 330 is expressed as follows.

M(m₁,m₂,k)=D(M_{E}_{_{D}}(n₁,n₂,k)) (6),

where D (.) indicates down sampling with respect to horizontal and vertical directions.

The edge detection unit 340 detects an edge from the input low-resolution image frame y(m₁,m₂,k) in order to generate an edge map E(m₁, m₂,k) and detects the direction of the edge in order to generate edge direction information θₑ.

The generation of the edge map E(m₁,m₂,k) is performed as follows. The edge detection unit 340 defines a region having larger gradients with respect to horizontal and vertical directions than a predetermined threshold Th_{E} in the low-resolution image frame y(m₁,m₂,k) as an edge region and defines the other regions as non-edge regions.

$$E ( {m}_{1} , {m}_{2} , k ) = \{ \begin{matrix}1 , & if \sqrt{{( \frac{\partial y}{\partial {m}_{1}} )}^{2} + {( \frac{\partial y}{\partial {m}_{2}} )}^{2}} > {Th}_{E} \\ 0 , & otherwise\end{matrix} , \qquad ( 7 )$$

A region corresponding to E(m₁,m₂,k)=1 means an edge region and a region corresponding to E(m₁,m₂,k)=O means a non-edge region.

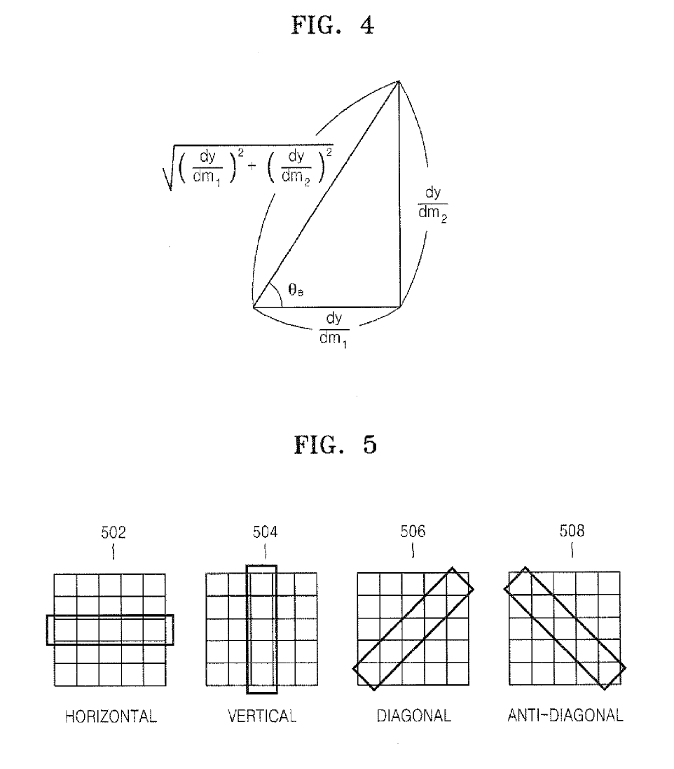

FIG. 4 is a view for explaining calculation of edge direction information according to an exemplary embodiment of the present invention.

As illustrated in FIG. 4, when the horizontal side of a triangle is a horizontal change rate of a low-resolution image frame y, i.e.,

$$\frac{d y}{d {m}_{1}} ,$$

and the vertical side of the triangle is a vertical change rate of the low-resolution image frame y, i.e.,

$$\frac{d y}{d {m}_{2}} ,$$

the oblique side of the triangle is

$$\sqrt{{( \frac{d y}{d {m}_{1}} )}^{2} + {( \frac{d y}{d {m}_{2}} )}^{2}} .$$

In this triangle, the included angle θₑ between the oblique side and the horizontal side is an edge direction and is calculated as follows. In other words, the edge detection unit 340 generates edge direction information θₑ by calculating Equation (8).

$${θ}_{e} = {tan}^{- 1} \frac{( \frac{d y}{d {m}_{2}} )}{( \frac{d y}{d {m}_{1}} )} \qquad ( 8 )$$

FIG. 5 is a view for explaining an edge direction according to an exemplary embodiment of the present invention. In the exemplary embodiment, the edge detection unit 340 approximates the edge direction as being a horizontal direction (0°) 502, a vertical direction (90°) 504, a diagonal direction (45°) 506, and an anti-diagonal direction (135°) 508. However, the edge direction information is not limited to these four directions and may further include various directions according to implementations.

The directional function generation unit 350 generates a directional point spread function based on the generated edge map and edge direction.

More specifically, the directional function generation unit 350 generates a colinear Gaussian function like Equation (9) for a pixel corresponding to E(m₁,m₂,k)=O, i.e., a pixel in a non-edge region.

$${h}_{{t}_{y}} ( {n}_{1 ,} {n}_{2} ; {m}_{1 ,} {m}_{2} ; k ) = \frac{1}{( 2 {πσ}^{2} )} {e}^{- \frac{( {n}_{1}^{2} - {n}_{2}^{2} )}{( 2 {σ}^{2} )}} \qquad ( 9 )$$

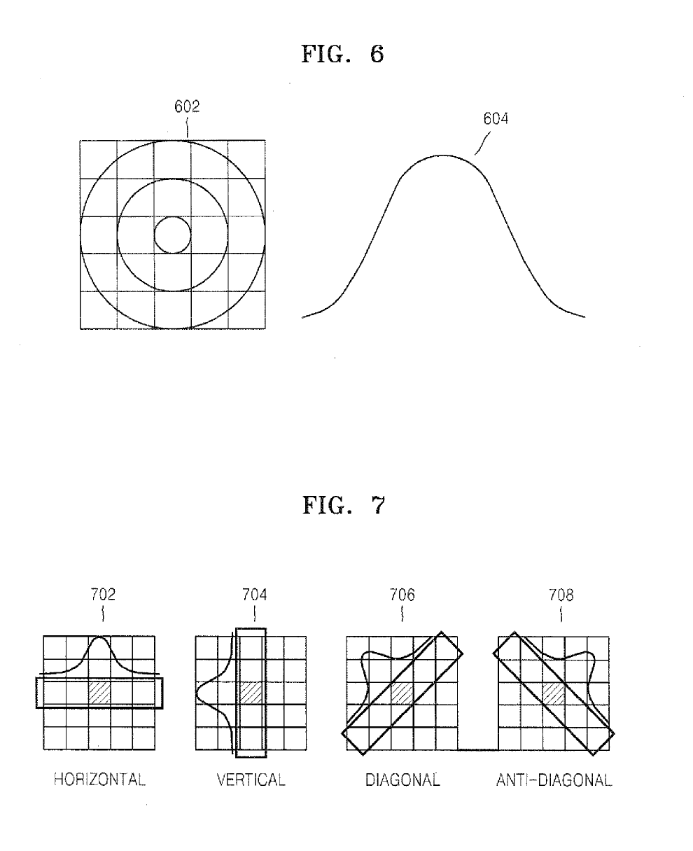

FIG. 6 is a view for explaining a colinear Gaussian function.

In FIG. 6, a graph 602 illustrates the colinear Gaussian function viewed from above, in which points located at the same distance from the center form the circular graph 602, and a graph 604 illustrates the colinear Gaussian function viewed from a side, in which function values of pixels decrease as distances of the pixels from the center increase.

As such, for pixels in a non-edge region, Gaussian functions having the same shape are generated regardless of directivities.

The directional function generation unit 350 generates a one-dimensional Gaussian function like Equation (10) for a pixel corresponding to E(m₁, m₂,k)=1, i.e., a pixel in an edge region, based on edge direction information.

$${h}_{{t}_{y}}^{′} ( {n}_{1 ,} {n}_{2} ; {m}_{1 ,} {m}_{2} ; k ) = \frac{1}{( \sqrt{2} πσ )} {e}^{- \frac{{n}_{e}^{2}}{\sqrt{2} σ}} , \qquad ( 10 )$$

where nₑ means a distance from a central pixel. In other words, nₑ at the central pixel is 0 and nₑ at a pixel located 1 pixel from the central pixel is 1.

Since function values of pixels decrease as distances of the pixels from the center increase in the one-dimensional Gaussian function, weights applied to the pixels decrease as distances of the pixels from the center increase.

FIG. 7 is a view for explaining the shape of the one-dimensional Gaussian function according to the edge direction.

Referring to FIG. 7, a dashed pixel indicates a central pixel and the shape of the one-dimensional Gaussian function is determined according to a direction with respect to the central pixel. In other words, the Gaussian function has a horizontal shape 702 when the edge direction is horizontal, a vertical shape 704 when the edge direction is vertical, a diagonal shape 706 when the edge direction is diagonal, and an anti-diagonal shape 708 when the edge direction is anti-diagonal.

To sum up, the directional function generation unit 350 generates a directional point spread function ĥₜ_{ᵣ}(n₁,n₂;m₁,m₂;k) that is defined in order to generate a colinear Gaussian function for a pixel in a non-edge region and a one-dimensional Gaussian function for a pixel in an edge region.

The directional point spread function ĥₜ_{ᵣ}(n₁,n₂;m₁,m₂;k) is expressed as follows.

$${h}_{{t}_{r}} ( {n}_{1} , {n}_{2} , {m}_{1} , {m}_{2} , k ) = \{ \begin{matrix}{h}_{{t}_{y}}^{′} ( {n}_{1} , {n}_{2} , {m}_{1} , {m}_{2} , k ) , & if E ( {m}_{1} , {m}_{2} , k ) = 1 \\ {h}_{{t}_{y}} ( {n}_{1} , {n}_{2} , {m}_{1} , {m}_{2} , k ) , & otherwise\end{matrix} \qquad ( 11 )$$

The POCS reconstruction unit 360 improves the resolution of an image using the low-resolution image frame y(m₁,m₂,k), the initially interpolated high-resolution image frame x(n₁,n₂,k), the motion vector u=(u,v), the outlier map M(m₁,m₂,k) and the directional point spread function ĥₜ_{ᵣ}(n₁,n₂;m₁,m₂;k).

In other words, the POCS reconstruction unit 360 calculates a residual term as in Equation (12) by substituting Equation (II) into Equation (1) and generates the convex set Cₜ_{ᵣ}(m₁,m₂,k) as in Equation (2).

$${r}^{( x )} ( {m}_{1} , {m}_{2} , k ) = y ( {m}_{1} , {m}_{2} , k ) - {\sum }_{( {n}_{1} , {n}_{2} )} x ( {n}_{1} , {n}_{2} , {t}_{r} ) {\hat{h}}_{{t}_{r}} ( {n}_{1} , {n}_{2} , {m}_{1} , {m}_{2} , k ) \qquad ( 12 )$$

Finally, the super-resolution image frame \hat{x}(n₁,n₂,tᵣ) is obtained as in Equation (13) by substituting Equation (11) into Equation (3).

$$\hat{x} ( {n}_{1} , {n}_{2} , {t}_{r} ) = x ( {n}_{1} , {n}_{2} , t ) + \{ \begin{matrix}\frac{( {r}^{( x )} ( {m}_{1} , {m}_{2} , k ) - {δ}_{0} ( {m}_{1} , {m}_{2} , k ) ) {\hat{h}}_{{t}_{r}} ( {n}_{1} , {n}_{2} , {m}_{1} , {m}_{2} , k )}{{\sum }_{{o}_{1}} {\sum }_{{o}_{2}} {\hat{h}}_{{t}_{r}}^{2} ( {o}_{1} , {o}_{2} , {m}_{1} , {m}_{2} , k )} , \\ 0 , \\ \frac{( {r}^{( x )} ( {m}_{1} , {m}_{2} , k ) + {δ}_{0} ( {m}_{1} , {m}_{2} , k ) ) {\hat{h}}_{{t}_{r}} ( {n}_{1} , {n}_{2} , {m}_{1} , {m}_{2} , k )}{{\sum }_{{o}_{1}} {\sum }_{{o}_{2}} {\hat{h}}_{{t}_{r}}^{2} ( {o}_{1} , {o}_{2} , {m}_{1} , {m}_{2} , k )} ,\end{matrix} \\ \begin{matrix}{r}^{( x )} ( {m}_{1} , {m}_{2} , k ) > {δ}_{0} ( {m}_{1} , {m}_{2} , k ) \\ \vert {r}^{( x )} ( {m}_{1} , {m}_{2} , k ) \vert \leq {δ}_{0} ( {m}_{1} , {m}_{2} , k ) \\ {r}^{( x )} ( {m}_{1} , {m}_{2} , k ) < {δ}_{0} ( {m}_{1} , {m}_{2} , k )\end{matrix} , \qquad ( 13 )$$

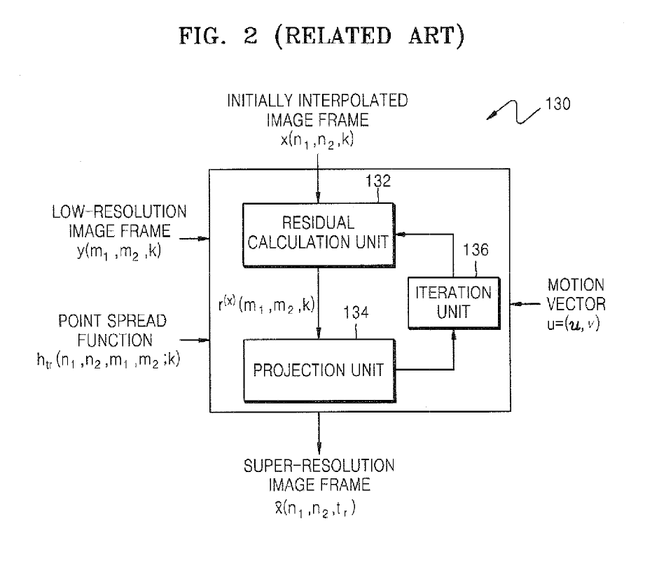

The operation and configuration of the POCS reconstruction unit 360 are well known to those of ordinary skill in the art and thus will not be described here. However, in an exemplary embodiment of the present invention, the POCS reconstruction unit 360 reduces incorrect compensation by excluding pixels having a large amount of motion prediction errors from a resolution conversion process based on the motion outlier map M(m₁,m₂,k) generated by the motion outlier detection unit 330. In other words, for the pixels having a large amount of motion prediction errors, the iteration unit 136 of FIG. 2 does not perform renewal as in Equation (13) so as not to improve the resolution of those pixels.

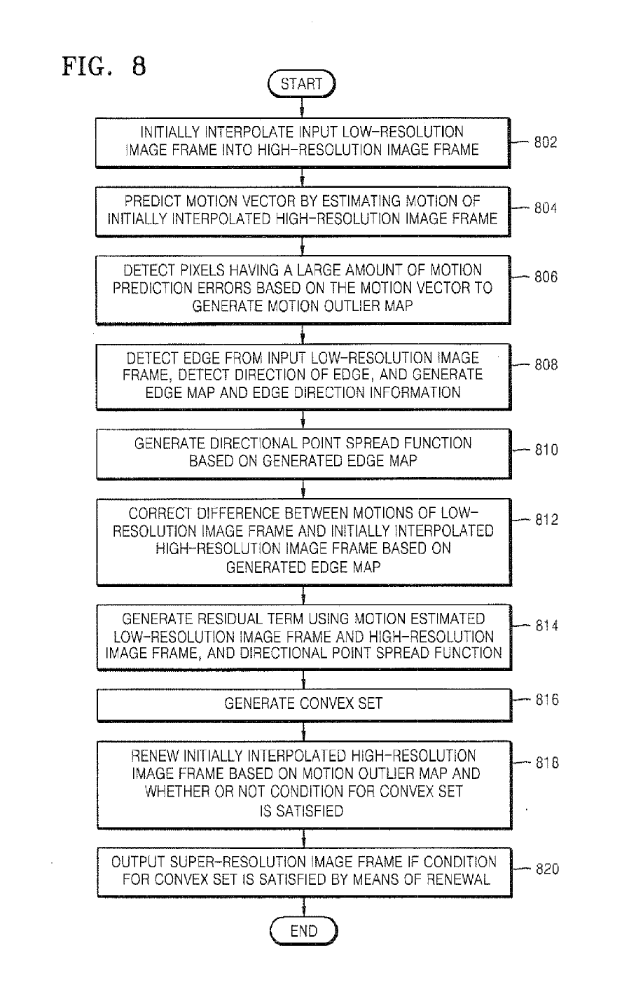

FIG. 8 is a flowchart illustrating an image resolution conversion method according to an exemplary embodiment of the present invention.

In operation 802, the input low-resolution image frame y(m₁,m₂,k) is initially interpolated into the high-resolution image frame x(n₁,n₂,tᵣ).

In operation 804, motion of the initially interpolated high-resolution image frame x(n₁, n₂,k) is estimated in order to predict the motion vector u=(u,v).

In operation 806, pixels having a large amount of motion prediction errors are detected based on the estimated motion information in order to generate the motion outlier map M(m₁,m₂,k).

In operation 808, an edge is detected from the input low-resolution image frame y(m₁,m₂,k), the direction of the detected edge is detected, and the edge map E(m₁,m₂,k) and the edge direction information θₑ are generated.

In operation 810, the directional point spread function is generated based on the generated edge map E(m₁, m₂,k) and edge direction information θₑ.

In operation 812, a difference between motions of the low-resolution image frame y(m₁,m₂,k) and the initially interpolated high-resolution image frame x(n₁,n₂,tᵣ) is corrected using the motion vector u=(u,v).

In operation 814, the residual term is generated using the low-resolution image frame y(m₁, m₂,k) and the high-resolution image frame x(n₁,n₂,tᵣ) whose motions are corrected and using the directional point spread function ĥₜ_{ᵣ}(n₁,n₂;m₁,m₂;k).

In operation 816, the convex set Cₜ_{ᵣ}(m₁,m₂,k) is generated.

In operation 818, the initially interpolated high-resolution image frame x(n₁,n₂,tᵣ) is renewed based on the motion outlier map (m₁, m₂,k) and whether or not the condition for the convex set Cₜ_{ᵣ}(m₁,m₂,k) is satisfied.

More specifically, if the condition for the convex set Cₜ_{ᵣ}(m₁,m₂,k) is not satisfied, i.e., if the residual term r^{(x)}(m₁,m₂,k) is less than or equal to the threshold δ₀(m₁,m₂,k) as in Equation (13), the high-resolution image frame x(n₁,n₂,tᵣ) is renewed. However, for pixels that have a large amount of motion prediction errors based on the motion outlier map M(m₁,m₂,k), the high-resolution image frame x(n₁,n₂,tᵣ) is not renewed.

In operation 820, if the condition for the convex set Cₜ_{ᵣ}(m₁,m₂,k) is satisfied by means of the renewal, the super-resolution image frame \hat{x}(n₁,n₂,tᵣ) is output.

Meanwhile, an exemplary embodiment of the present invention can be embodied as a program that can be implemented on computers and can be implemented on general-purpose digital computers executing the program using recording media that can be read by computers.

Examples of the recording media include magnetic storage media such as read-only memory (ROM), floppy disks, and hard disks, optical data storage devices such as CD-ROMs and digital versatile discs (DVD), and carrier waves such as transmission over the Internet.

According to exemplary embodiments of the present invention, by using an appropriate point spread function corresponding to the direction of a detected edge, it is possible to improve resolution while maintaining the edge.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image resolution conversion method comprising:
detecting an edge region and a direction of the edge region in an input low-resolution image frame in order to generate an edge map and edge direction information;
generating a directional point spread function based on the generated edge map and the edge direction information;
interpolating the input low-resolution image frame into a high-resolution image frame;
generating a residual term based on the input low-resolution image frame, the high-resolution image frame, and the directional point spread function; and
renewing the high-resolution image frame according to a result of comparing the residual term with a threshold.

2. The image resolution conversion method of claim 1, further comprising:
predicting a motion vector by estimating motion of the high-resolution image frame; and
generating a motion outlier map by detecting pixels having an amount of motion prediction errors based on the motion vector,
wherein the high-resolution image frame is not renewed for the pixels having a large amount of motion prediction errors based on the motion outlier map.

3. The image resolution conversion method of claim 1, wherein an area having gradients with respect to horizontal and vertical directions which are larger than a predetermined threshold is determined to be the edge region in the low-resolution image frame.

4. The image resolution conversion method of claim 1, wherein the edge direction information is generated using a horizontal change rate of the low-resolution image frame and a vertical change rate of the low-resolution image frame.

5. The image resolution conversion method of claim 1, wherein the edge direction information is approximated to four directions including a horizontal direction, a vertical direction, a diagonal direction, and an anti-diagonal direction.

6. The image resolution conversion method of claim 4, wherein the edge direction information is approximated to four directions including a horizontal direction, a vertical direction, a diagonal direction, and an anti-diagonal direction.

7. The image resolution conversion method of claim 1, wherein the generating the directional point spread function comprises generating a colinear Gaussian function for a pixel in a non-edge region.

8. The image resolution conversion method of claim 1, wherein the generating the directional point spread function comprises generating a one-dimensional Gaussian function for a pixel in the edge region according to the direction of the edge region.

9. The image resolution conversion method of claim 1, wherein the interpolating is performed using bilinear interpolation or bicubic interpolation.

10. The image resolution conversion method of claim 1, wherein the residual term is obtained by subtracting a product of the high-resolution image frame and the directional point spread function from the input low-resolution image frame.

11. The image resolution conversion method of claim 1, wherein the renewing is performed if an absolute value of the residual term is greater than the threshold.

12. An image resolution conversion apparatus comprising:
an edge detection unit which detects an edge region and a direction of the edge region in an input low-resolution image frame in order to generate an edge map and edge direction information;
a directional function generation unit which generates a directional point spread function based on the edge map and the edge direction information generated by the edge detection unit;
an interpolation unit which interpolates the input low-resolution image frame into a high-resolution image frame;
a residual term calculation unit which generates a residual term based on the input low-resolution image frame, the high-resolution image frame, and the directional point spread function; and
an iteration unit which renews the high-resolution image frame according to a result of comparing the residual term with a threshold.

13. The image resolution conversion apparatus of claim 12, further comprising:
a motion estimation unit which predicts a motion vector by estimating motion of the high-resolution image frame; and
a motion outlier detection unit which generates a motion outlier map by detecting pixels having a large amount of motion prediction errors based on the motion vector.

14. The image resolution conversion apparatus of claim 12, wherein the edge detection unit determines an area having larger gradients with respect to horizontal and vertical directions which are larger than a predetermined threshold to be the edge region in the low-resolution image frame.

15. The image resolution conversion apparatus of claim 12, wherein the edge detection unit generates the edge direction information using a horizontal change rate of the low-resolution image frame and a vertical change rate of the low-resolution image frame.

16. The image resolution conversion apparatus of claim 12, wherein the edge detection unit approximates edge direction information to four directions including a horizontal direction, a vertical direction, a diagonal direction, and an anti-diagonal direction.

17. The image resolution conversion apparatus of claim 12, wherein the directional point spread function generation unit generates a colinear Gaussian function for a pixel in a non-edge region.

18. The image resolution conversion apparatus of claim 12, wherein the directional point spread function generation unit generates a one-dimensional Gaussian function for a pixel in the edge region according to the direction of the edge region.

19. The image resolution conversion apparatus of claim 12, wherein the interpolation unit performs the interpolation using bilinear interpolation or bicubic interpolation.

20. The image resolution conversion apparatus of claim 12, wherein the residual term calculation unit calculates the residual term by subtracting a product of the high-resolution image frame and the directional point spread function from the input low-resolution image frame.

21. The image resolution conversion apparatus of claim 12, wherein the iteration unit performs the renewal if an absolute value of the residual term is greater than the threshold.

22. The image resolution conversion apparatus of claim 13, wherein the iteration unit does not renew the high-resolution image frame for the pixels having a large amount of motion prediction errors based on the motion outlier map.

23. A computer-readable recording medium having recorded thereon a program for implementing an image resolution conversion method, the image resolution conversion method comprising:
detecting an edge region and a direction of the edge region in an input low-resolution image frame in order to generate an edge map and edge direction information;
generating a directional point spread function based on the generated edge map and the edge direction information;
interpolating the input low-resolution image frame into a high-resolution image frame;
generating a residual term based on the input low-resolution image frame, the high-resolution image frame, and the directional point spread function; and
renewing the high-resolution image frame according to a result of comparing the residual term with a threshold.
